(19) United States
(12) Patent Application Publication
(10) Pub. No.: US 2008/0174587 A1
(43) Pub. Date: Jul. 24, 2008

(54) PLASMA DISPLAY AND DRIVING METHOD THEREOF

(75) Inventor: Jin-Boo Son, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/942,055

(22) Filed: Nov. 19, 2007

(30) Foreign Application Priority Data
Jan. 19, 2007 (KR) 10-2007-0006166

(51) Int. Cl. G06F 3/038; G09G 3/28

(52) U.S. Cl. 345/211; 345/66

(57) ABSTRACT

In a plasma display device, a transistor is coupled between a power source that supplies a Ve voltage and a sustain electrode, and a capacitor is coupled between a power source that supplies a Ve voltage and a ground terminal. During a sustain period, a Vs voltage and 0V are alternately applied. Since the Vs voltage is set to be less than the Ve voltage, the capacitor is charged with the Vs voltage through a body diode of the transistor when the Vs voltage is applied to the sustain electrode during the sustain period. Therefore, the Vs voltage charged during a period ranging from after the sustain period to before the transistor is turned on, is discharged to be less than the Ve voltage. Accordingly, only one transistor needs to be used between the power source that supplies the Ve voltage and the sustain electrode.

### CROSS-REFERENCE TO RELATED APPLICATION

This application claims the benefit of Korean Patent Application No. 2007-6166 filed on Jan. 19, 2007 in the Korean Intellectual Property Office, the disclosure of which is incorporated herein by reference.

### BACKGROUND OF THE INVENTION

1. Field of the Invention

An aspect of the present invention relates to a plasma display device and a driving method thereof.

2. Description of the Related Art

A plasma display device is a flat panel display that uses plasma generated by a gas discharge to display characters or images. The plasma display device includes a plasma display panel (PDP) wherein tens to millions of discharge cells are arranged in a matrix format, depending on the PDP's size.

Generally, in a plasma display device, one frame is divided into respectively weighted subfields. Grayscales may be expressed by a combination of weights from among the subfields, which are used to perform a display operation. Light emitting cells and non-light-emitting cells are selected by address discharges generated between a scan electrode and an address electrode, respectively applied with a scan pulse and an address pulse during an address period of each subfield, and a sustain pulse. The sustain pulse having a sustain voltage applied in reverse phases to the scan electrode and the sustain electrode respectively during a sustain period so that an actual image is displayed by sustain discharges generated between the scan electrode and the sustain electrode.

In the address period, many negative (−) wall charges are formed on the sustain electrode after the address discharge so that a voltage of the sustain electrode is biased with a positive voltage for efficient generation of a sustain discharge during the sustain period. In this case, the positive voltage biased to the sustain electrode is set to be less than a sustain voltage. Accordingly, two transistors are required to be coupled back-to-back between the sustain electrode and a power source that supplies the positive voltage, thereby increasing the number of circuit elements.

The above information disclosed in this Background section is only for enhancement of understanding of the background of the invention and therefore it may contain information that does not form the prior art that is already known in this country to a person of ordinary skill in the art.

### SUMMARY OF THE INVENTION

An aspect of the present invention provides a plasma display device supplying a bias voltage to a sustain electrode with only one transistor in an address period, and a driving method thereof.

An exemplary plasma display device according to one embodiment of the present invention includes a plurality of first electrodes, a plurality of second electrodes, a first transistor, a second transistor, a third transistor, and a capacitor. The first transistor is coupled between the plurality of first electrodes and a first power source that supplies a first voltage. The second transistor is coupled between the plurality of first electrodes and a second power source that supplies a second voltage that is less than the first voltage. The third transistor is coupled between the second power source and a third power source that supplies a third voltage that is between the first voltage and the second voltage. The capacitor is coupled between the third power source and a fourth power source that supplies a fourth voltage that is less than the third voltage, and is charged with the first voltage when the first transistor is turned on. In a reset period, a voltage charged in the capacitor is discharged to be less than the third voltage during a partial period of a first period during which a voltage of the plurality of second electrodes is gradually increased, the partial period being consecutive to a sustain period.

An exemplary method according to another embodiment of the present invention drives a plasma display device having a plurality of first electrodes extending in one direction. The method includes: during a first period, turning on a transistor coupled between a first power source that supplies a first voltage and the plurality of first electrodes and applying the first voltage to the plurality of first electrodes; during a sustain period, alternately applying a second voltage that is greater than the first voltage and a third voltage that is less than the second voltage; during the sustain period, charging a capacitor with the first voltage while applying the second voltage to the plurality of first electrodes, the capacitor coupled between the first power source and a second power source that supplies a fourth voltage that is less than the first voltage; and discharging the voltage charged in the capacitor to be less than the first voltage during at least a partial period of a period from after the sustain period to before the first period.

An exemplary plasma display device according to another embodiment of the present invention includes a plurality of first electrodes, a plurality of second electrodes, a sustain driver, a first transistor, and a capacitor. The plurality of first and second electrodes perform a display operation. The sustain driver is coupled to the plurality of first electrodes, and alternately applies a first voltage and a second voltage to the plurality of first electrodes. The second voltage is less than the first voltage. The first transistor is coupled between a first power source that supplies a third voltage that is less than the first voltage and the plurality of first electrodes. The capacitor is coupled between the first power source and a second power source that supplies a fourth voltage. The fourth voltage is less than the third voltage, and the capacitor is charged with the first voltage when the first voltage is applied to the plurality of first electrodes during the sustain period. The capacitor is discharged to less than the third voltage during a partial period of a period from after the sustain period to before the first transistor is turned on. In this case, the capacitor is discharged to less than the third voltage during a partial period of a period from after the sustain period to before the first transistor is turned on.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows a plasma display device according to an exemplary embodiment of the present invention.

FIG. 2 schematically shows a driving circuit of a sustain electrode driver according to an exemplary embodiment of the present invention.

FIG. 3 shows driving waveforms of the plasma display device according to an exemplary embodiment of the present invention.

FIG. 4 and FIG. 5 respectively show signal timing diagrams of sustain electrode circuits according to first and second exemplary embodiments of the present invention.

### DETAILED DESCRIPTION OF THE EMBODIMENTS

In. Reference will now be made in detail to the present embodiments of the present invention, examples of which are illustrated in the accompanying drawings, wherein like reference numerals refer to the like elements throughout. The embodiments are described below in order to explain the present invention by referring to the figures.

Accordingly, the drawings and description are to be regarded as illustrative in nature and not restrictive. As noted above, like reference numerals designate like elements throughout the specification. When it is described that an element is connected to another element, the element may be directly connected to the other element or connected to the other element through a third element.

A plasma display device and a driving method thereof according to an exemplary embodiment of the present invention will now be described in further detail.

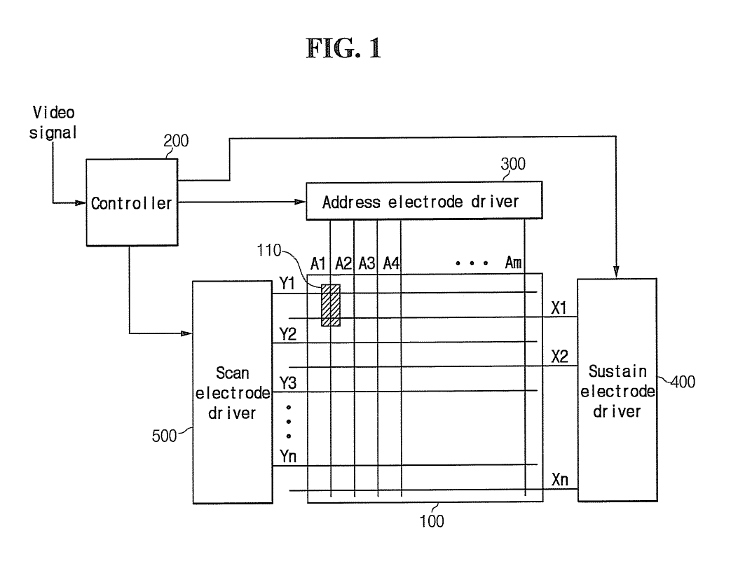

FIG. 1 shows a plasma display device according to an exemplary embodiment of the present invention.

As shown in FIG. 1, the plasma display device includes a plasma display panel (PDP) 100, a controller 200, an address electrode driver 300, a sustain electrode driver 400, and a scan electrode driver 500.

The PDP 100 includes a plurality of address electrodes A1 to Am extending in a column direction, and a plurality of sustain electrodes X1 to Xn and a plurality of scan electrodes Y1 to Yn extending in a row direction. Hereinafter, the address electrode, the sustain electrode, and the scan electrode will be respectively referred to as an A electrode, an X electrode, and a Y electrode. Generally, the X electrodes X1 to Xn are respectively formed to correspond to the Y electrodes Y1 to Yn, and the X and Y electrodes perform a display operation in order to display an image during a sustain period. The Y electrodes Y1 to Yn and the X electrodes X1 to Xn may perpendicularly cross each other. A discharge space formed at a crossing region of the A electrodes A1 to Am with the sustain and scan electrodes X1 to Xn and Y1 to Yn forms a discharge cell (hereinafter referred to as a “cell”) 110. This structure of the PDP 100 is merely exemplary, and panels having different structures to which the following driving waveforms can be applied are also part of the present invention.

The controller 200 externally receives video signals and outputs an A electrode driving control signal, an X electrode driving control signal, and a Y electrode driving control signal. In addition, the controller 200 controls the plasma display device by dividing a frame into a plurality of subfields.

The address electrode driver 300 receives an A electrode driving control signal from the controller 200, and applies a display data signal for selecting discharge cells to be displayed to the respective A electrodes.

The sustain electrode driver 400 receives the X electrode driving control signal from the controller 200 and applies a driving voltage to the X electrode.

The scan electrode driver 500 receives the Y electrode driving control signal from the controller 200, and applies a driving voltage to the Y electrode.

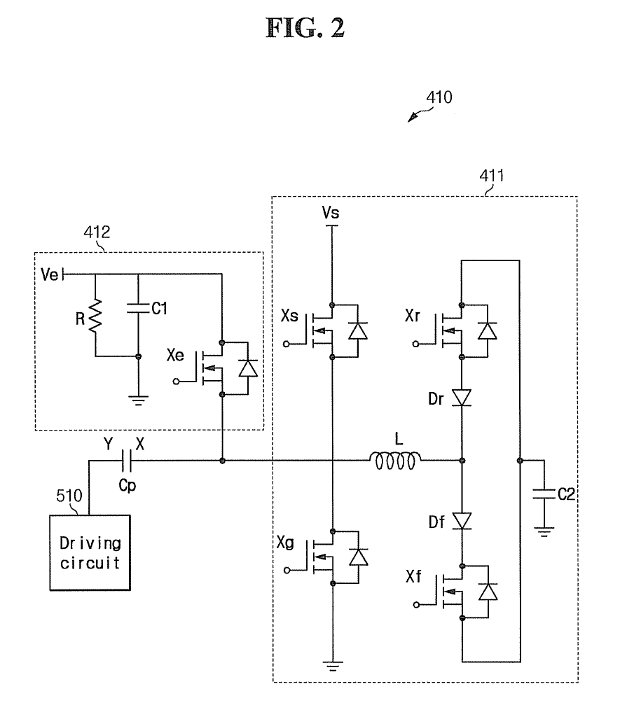

A driving circuit of the plasma display device according to the exemplary embodiment of the present invention will be described in further detail with reference to FIG. 2.

FIG. 2 schematically shows a driving circuit 410 of the sustain electrode driver 400 according to the exemplary embodiment of the present invention. FIG. 2 illustrates one X electrode among the plurality of X electrodes X1 to Xn and one Y electrode among the plurality of Y electrodes Y1 to Yn, and a capacitance component formed by the X electrode X and the Y electrode Y is illustrated as a panel capacitor Cp. In addition, as illustrated in FIG. 2 the driving circuit 410 is coupled to the X electrode X, the Y electrode can be coupled to the driving circuit 510. The driving circuit 510 may be formed in the scan electrode driver 500.

As shown in FIG. 2, the driving circuit 410 includes a sustain driver 411 and a bias unit 412. The sustain driver 411 includes an inductor L, transistors Xs, Xg, Xr, and Xf, and diodes Dr and Df. The bias unit 412 includes a transistor Xe, a capacitor C1, and a resistor R. In FIG. 2, the transistors Xe, Xs, Xg, Xr, and Xf are respectively illustrated as n-channel field effect transistors, particularly as n-channel metal oxide semiconductor (NMOS) transistors, and a body diode may be formed in a source-to-drain direction of each of the transistors Xe, Xs, Xg, Xr, and Xf. Other transistors having similar functions to those of the transistors Xe, Xs, Xg, Xr, and Xf can replace the NMOS transistors. Although the transistors Xe, Xs, Xg, Xr, and Xf are respectively illustrated as an individual transistor in FIG. 2, each of the transistors Xe, Xs, Xg, Xr, and Xf may also be formed as a plurality of transistors coupled in parallel.

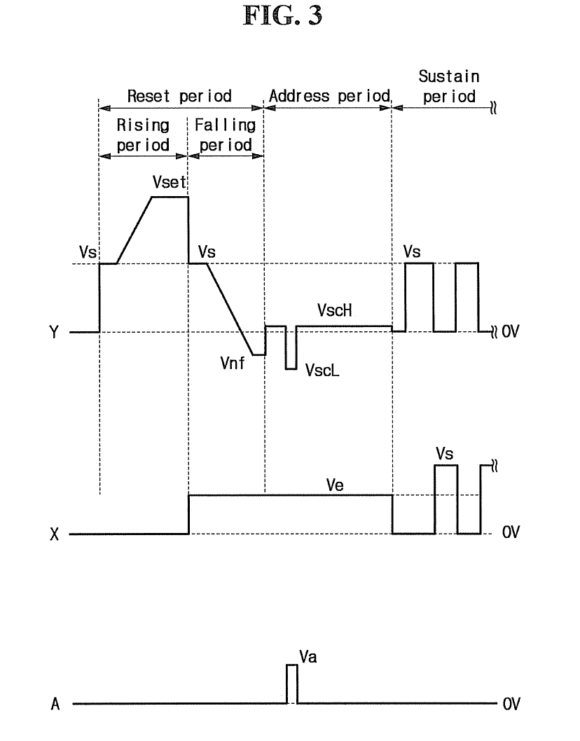

In further detail, a drain of the transistor Xs is coupled to a power source Vs that supplies a high level voltage (i.e., Vs voltage in FIG. 3), and a source of the transistor Xs is coupled to the X electrode X. A source of the transistor Xg is coupled to a power source (i.e., a ground terminal in FIG. 2) that supplies a low level voltage (i.e., 0V in FIG. 3), and a drain of the transistor Xg is coupled to the X electrode X. A first terminal of the inductor L is coupled to the X electrode X, and a second terminal of the inductor L is coupled to a cathode of the diode Dr and an anode of the diode Df. A source of the transistor Xr is coupled to an anode of the diode Dr and a drain of the transistor Xf is coupled to the cathode of the diode Df. A drain of the transistor Xr and a source of the transistor Xf are coupled to a power recovering capacitor C2. The capacitor C2 supplies a voltage (e.g., Vs/2) between the high level voltage Vs and the low level voltage 0V. The diode Dr establishes a current path for increasing a voltage of the X electrode X, and the diode Df establishes a current path for decreasing the voltage of the X electrode X.

In the case that the transistors Xr and Xf do not respectively have the body diode, the diodes Dr and Df can be omitted. In addition, positions of the diode Dr and the transistor Xr may be switched, and positions of the diode Df and the transistor Xf may be switched. In this case, the inductor L, the transistors Xr and Xf, the diodes Dr and Df, and the capacitor C2 operate as power recovery unit or source for recovering reactive power formed by a sustain pulse and reusing the recovered reactive power.

That is, when the transistor Xr is turned on, energy charged in the capacitor C2 is supplied to the X electrode X through the inductor L so that the voltage of the X electrode X can be increased, and when the transistor Xf is turned on, energy charged in the panel capacitor Cp is recovered to the capacitor C2 so that the voltage of the X electrode X can be decreased.

A drain of the transistor Xe is coupled to the X electrode X and a source of the transistor Xe is coupled to a power source Ve that supplies a Ve voltage. The capacitor C1 is coupled between the power source Ve and the ground terminal. The resistor R is coupled in parallel with the capacitor C1.

FIG. 3 shows driving waveforms of the plasma display device according to the exemplary embodiment of the present invention. FIG. 3 illustrates one X electrode X and one Y electrode Y for better understanding and ease of description.

As shown in FIG. 3, in a rising period of a reset period, the transistor Xg is turned on so as to gradually increase the voltage of the Y electrode Y from the Vs voltage to a Vset voltage while maintaining a voltage of the X electrode X at a reference voltage level (i.e., 0V in FIG. 3). FIG. 3 illustrates that the voltage of the Y electrode Y increases according to a ramp pattern. Then, a weak discharge is generated between the Y electrode Y and the X electrode X and between the Y electrode Y and the A electrode A while the voltage of the Y electrode Y increases so that negative (−) wall charges are formed on the Y electrode Y and positive (+) wall charges are formed on the X and A electrodes X and A.

In a falling period of the reset period, the transistor Xe is turned on so as to gradually decrease the voltage of the Y electrode Y from the Vs voltage to a Vnf voltage while applying the Ve voltage to the X electrode. Then, a weak discharge is generated between the Y electrode Y and the X electrode X and between the Y electrode Y and the A electrode A while the voltage of the Y electrode decreases so that the negative (−) wall charges formed on the Y electrode Y and the positive (+) wall charges formed on the X and A electrodes X and A are erased. In general, a (Vnf-Ve) voltage is set close to a discharge firing voltage between the Y electrode Y and the X electrode X. Then, a wall voltage between the Y electrode Y and the X electrode X becomes close to 0V so that a discharge cell that has not experienced an address discharge in an address period is prevented from being misfired in a sustain period.

In the address period, a scan pulse having a VscL voltage is sequentially applied to the plurality of Y electrodes Y while maintaining the voltage of the X electrode X at the Ve voltage level so as to select cells to be turned on. An address pulse having a Va voltage is applied to a selected electrode A among a plurality of cells formed by the Y electrode Y applied with the VscL voltage and the X electrode X. Then, an address discharge is generated between the A electrode A applied with the Va voltage and the Y electrode Y applied with the VscL voltage and between the Y electrode Y applied with the VscL voltage and the X electrode X applied with the Ve voltage so that positive (+) wall charges are formed on the Y electrode and negative (−) wall charges are formed on the Y electrode Y. A Y electrode Y to which the VscL voltage is not applied is applied with a VscH voltage that is greater than the VscL voltage, and an A electrode to which the Va voltage is not applied is applied with the reference voltage.

During the sustain period, a sustain pulse alternately having the high level voltage (i.e., Vs voltage in FIG. 3) and the low level voltage (i.e., 0V in FIG. 3) is applied to the Y electrode Y and to the X electrode X in reverse phases. That is, the Vs voltage is applied to the Y electrode Y when the 0V is applied to the X electrode, and the Vs voltage is applied to the X electrode X when the 0V is applied to the Y electrode Y. Subsequently, the process of alternately applying the sustain discharge pulses of voltages Vs to the Y electrode Y and the Vs voltage to the X electrode X is repeated a number of times corresponding to a weight value of a corresponding subfield. In this case, the transistors Xs and Xg are alternately turned on so that the sustain pulse can be applied to the X electrode X, and the sustain pulse can be applied to the X electrode X by using the power recovering unit or source. When using the power recovering unit or source, the transistor Xr, the transistor Xs, the transistor Xf, and the transistor Xg are sequentially turned on, and this process is repeated a number of times corresponding to a weight of the corresponding subfield.

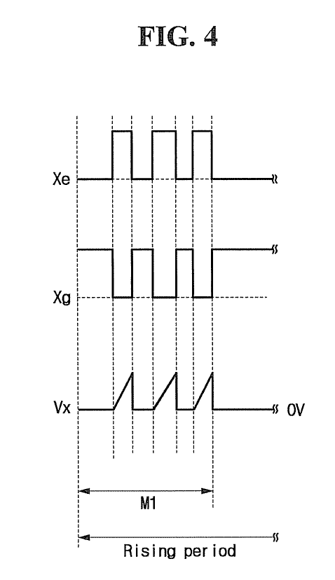

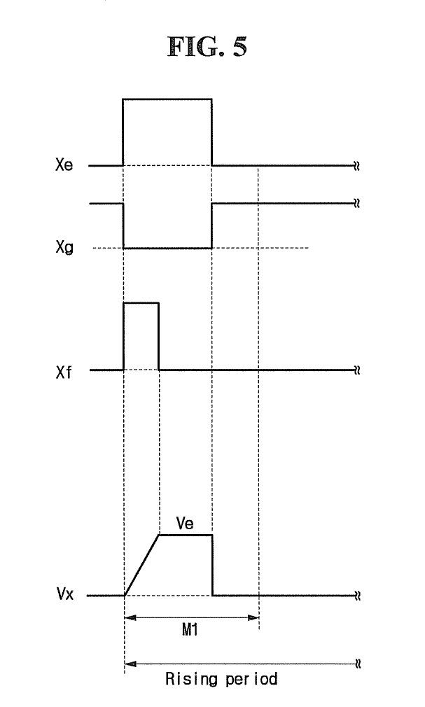

While the transistor Xs is in the turn-on state in the sustain period, the capacitor C1 is charged with the Vs voltage through the body diode of the transistor Xe. When the capacitor C1 is charged with the Vs voltage, the X electrode may be applied with the Vs voltage that is greater than the Ve voltage during the falling period of the reset period. Therefore, the Vs voltage charged in the capacitor C1 is forcibly discharged until the Vs voltage becomes less than the Ve voltage before the falling period of the reset period according to the exemplary embodiment of the present invention. In this way, one transistor Xs can be used between the power source Ve and the X electrode X. Referring to FIG. 4 and FIG. 5, the following embodiments will be focused on the discharge of the Vs voltage charged in the capacitor C2 so as to decrease the Vs voltage to the Ve voltage from after the sustain period and before the falling period of the reset period.

FIG. 4 and FIG. 5 respectively show signal timing diagrams of a driving circuit 410 according to first and second exemplary embodiments of the present invention.

As shown in FIG. 4, in the rising period of the reset period, the transistor Xg and the transistor Xe are alternately turned on a predetermined number of times during an Ml period before a weak discharge is generated between a Y electrode Y and an X electrode X and between a Y electrode Y and an A electrode A. While the transistor Xg is in the turn-on state, a voltage Vx of the X electrode X becomes 0V, and while the transistor Xe is in the turn-on state, the voltage charged in the capacitor C1 is discharged so that the Vx voltage of the X electrode X is increased. The voltage charged in the capacitor C1 can be discharged to be less than the Ve voltage by repeating the above operation. When the voltage charged in the capacitor C1 is less than the Ve voltage, the transistor Xe is turned on and thus the Ve voltage may be applied to the X electrode through the power source Ve in the falling period of the reset period.

As shown in FIG. 5, according to the second exemplary embodiment of the present invention, after the transistors Xe and Xf are turned on during a predetermined period of the Ml period, the transistor Xg is turned on during the rest of the Ml period. When the transistors Xe and Xf are turned on, the voltage charged in the capacitor C1 is charged through a path formed from the capacitor C1 through the transistor Xe, the inductor L, the diode Df, the transistor Xf, and the capacitor C2 to the ground terminal 0, and the voltage charged in the capacitor C1 may be discharged to be less than the Ve voltage by controlling the turn-on period of the transistors Xe and Xf. In this case, the Vx voltage of the X electrode X is increased. As described above, only one transistor Xe can be used between the power source Ve and the X electrode X by discharging the Vs voltage charged in the capacitor C1 to be less than the Ve voltage during the M1 period.

Although it is described in the first and second exemplary embodiments of the present invention that the sustain pulse alternately having the Vs voltage and the 0V is applied to the Y electrode Y and the X electrode X in reverse phase during the sustain period, a different sustain pulse may be applied. For example, a sustain pulse alternately having a Vs voltage and a −Vs voltage may be applied to the X electrode X while a reference voltage (e.g., 0V) is applied to the Y electrode Y. In this case, since the Vs voltage is charged in the capacitor C1 while the Vs voltage is applied to the X electrode X, the voltage charged in the capacitor C1 can be discharged by applying the first and second exemplary embodiments of the present invention.

In addition, in order to select cells to be turned on and cells not to be turned on among a plurality of discharge cells, as shown in FIG. 3, a selective write address method that selects cells to be turned on and forms wall charges may be used, and a selective erase address method that selects cells not to be turned on and erases wall charges may also be used. When such a selective erase address method is applied to a subfield (e.g., n-th subfield), a sustain period of the immediately previous subfield (e.g., (n−1)-th subfield) may be located immediately before an address period of the n-th subfield. In this case, a voltage charged in the capacitor C1 can be discharged by applying the first and second exemplary embodiments of the present invention during a predetermined time period between the sustain period and the address period.

According to the exemplary embodiments of the present invention, only one transistor needs to be coupled between a power source that supplies a positive (+) voltage and a sustain electrode, thereby reducing the number of circuit elements.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display device comprising:
a plurality of first electrodes;
a plurality of second electrodes;
a first transistor coupled between the plurality of first electrodes and a first power source that supplies a first voltage;
a second transistor coupled between the plurality of first electrodes and a second power source that supplies a second voltage that is less than the first voltage;
a third transistor coupled between the plurality of first electrodes and a third power source that supplies a third voltage that is between the first voltage and the second voltage; and
a capacitor coupled between the third power source and a fourth power source that supplies a fourth voltage that is less than the third voltage, and charged with the first voltage when the first transistor is turned on,
wherein, in a reset period, a voltage charged in the capacitor is discharged to be less than the third voltage during a partial period of a first period during which a voltage of the plurality of second electrodes is gradually increased, the partial period being consecutive to a sustain period.

2. The plasma display device of claim 1, wherein, in the reset period, a voltage of the plurality of second electrodes is gradually decreased while the third voltage is applied to the plurality of first electrodes during a second period that is consecutive to the first period.

3. The plasma display device of claim 2, wherein the first transistor and the second transistor are alternately turned on during the sustain period.

4. The plasma display device of claim 3, wherein the second transistor and the third transistor are alternately turned on during the partial period.

5. The plasma display device of claim 2, further comprising:
an inductor coupled to the plurality of first electrodes; and
a fourth transistor coupled between the inductor and a power recovering power source that supplies a third voltage that is between the first voltage and the third voltage,
wherein the second and fourth transistors are turned on during a third period of the partial period.

6. The plasma display device of claim 5, wherein the third transistor is turned on during the rest of the first period, excluding the partial period, and
a discharge is generated between the plurality of first electrodes and the plurality of second electrodes during the rest of the first period.

7. A method for driving a plasma display device having a plurality of first electrodes extending in one direction, the method comprising:
during a first period, turning on a transistor coupled between a first power source that supplies a first voltage and the plurality of first electrodes, and applying the first voltage to the plurality of first electrodes;
during a sustain period, alternately applying a second voltage that is greater than the first voltage and a third voltage that is less than the second voltage;
during the sustain period, charging a capacitor with the first voltage while applying the second voltage to the plurality of first electrodes, the capacitor coupled between the first power source and a second power source that supplies a fourth voltage that is less than the first voltage; and
discharging the first voltage charged in the capacitor to a voltage less than the first voltage during at least a partial period of a period extending from after the sustain period to before the first period.

8. The method of claim 7, wherein the plasma display device further comprises a plurality of second electrodes that perform a display operation together with the plurality of first electrodes, and the first period comprises an address period during which a scan pulse is sequentially applied to the plurality of second electrodes.

9. The method of claim 8, wherein the first period further comprises a period for gradually decreasing the voltage of the plurality of second electrodes.

10. A plasma display device having a plurality of first electrodes and a plurality of second electrodes that perform a display operation together with the plurality of first electrodes, the plasma display device comprising:
a sustain driver coupled to the plurality of first electrodes, and alternately applying a first voltage and a second voltage to the plurality of first electrodes, the second voltage being greater than the first voltage;
a first transistor coupled between a first power source that supplies a third voltage that is less than the first voltage and the plurality of first electrodes; and
a capacitor coupled between the first power source and a second power source that supplies a fourth voltage that is less than the third voltage and charged with the first voltage when the first voltage is applied to the plurality of first electrodes during the sustain period,
wherein the capacitor is discharged to be less than the third voltage during a partial period of a period from after the sustain period to before the first transistor is turned on.

11. The plasma display device of claim 10, wherein the first transistor is turned on during an address period.

12. The plasma display device of claim 11, wherein, in a reset period, the first transistor is turned on during a period in which a voltage of the second electrodes is gradually decreased.

13. The plasma display device of claim 12, wherein the partial period is included in a period during which the voltage of the second electrodes is gradually increased in the reset period.

14. The plasma display device of claim 10, wherein the sustain driver comprises a second transistor coupled between a third power source that supplies the second voltage and the plurality of first electrodes, and the first and second transistors are alternately turned on during the partial period.

15. The plasma display device of claim 10, wherein the sustain driver comprises:
an inductor coupled to the plurality of first electrodes; and
a second transistor coupled between the inductor and a power recovering power source that supplies a fifth voltage that is between the first voltage and the second voltage, and forming a path for gradually decreasing a voltage of the first electrodes,
wherein the first and second transistors are turned on during the partial period.
